(19) United States
(12) Patent Application Publication
(10) Pub. No.: US 2007/0074111 A1
(43) Pub. Date: Mar. 29, 2007

(54) METHOD AND SYSTEM FOR SELECTIVELY VIEWING THE CONTENT OF WEBSITES

(75) Inventors: Alexander Firshein, Newton, MA (US); Peter Hoe-Richardson, Chestnut Hill, MA (US); Gentian Shkurti, Danvers, MA (US); Andrew Youniss, Wellesley, MA (US)

Correspondence Address: BARLOW, JOSEPHS & HOLMES, LTD., 101 DYER STREET, 5TH FLOOR, PROVIDENCE, RI, 02903, US

(73) Assignee: ROCKET SOFTWARE, INC., Newton, MA (US)

(21) Appl. No.: 11/533,086

(22) Filed: Sep. 19, 2006

Related U.S. Application Data
(60) Provisional application No. 60/719,910, filed on Sep. 23, 2005.

(51) Int. Cl. G06F 17/00

(52) U.S. Cl. 715/530; 715/501.1; 715/513

(57) ABSTRACT

A method and system for selectively viewing the content of web sites is disclosed. In particular, the present invention is a plug-in toolbar that can be used with any standard web browser software to allow a user to selectively display, block or even rearrange selected content of arbitrary websites onto a blank webpage as desired.

### CROSS-REFERENCE TO RELATED APPLICATION

The present application claims priority to U.S. Provisional Patent Application 60/719,910, filed Sep. 23, 2005, the contents of which are incorporated herein by reference.

### BACKGROUND OF THE INVENTION

1. Field of the Invention

The present invention relates generally to the delivery of live web content and more particularly to a method and system to selectively view web content from one or more of user-specified sources to create user-customized web pages.

2. Background of the Related Art

The Internet has recently been popularized by the overwhelming and rapid success of the World Wide Web (WWW or Web). The Web is rapidly evolving as a standard for distributing, finding, and accessing information of any type. The amazing growth rate in the demand for data over the Internet is partly due to an increasing audience. Another factor fueling the Internet growth is the exploding amount of information that is now available on the Web. The Web has grown from thousands of Web sites to a several million Web sites in a very short period of time. The growth continues at an exponential rate.

The web is a valued source of information and a very useful tool in assisting businesses to market their products. Businesses offer detailed information about their products and services on their websites. The day of requesting specialized marketing material from businesses and awaiting the arrival of printed brochures in the mail is gone, as the information can be readily available to anyone by simply visiting a specific website. Moreover, the internet has provided businesses with a new forum to transact business with consumers and other businesses.

The web is also a valuable tool for entertainment and news organizations. In particular, news organizations are now able to reach new audiences with the latest breaking stories, not only in text format, but including photos to full streaming video and audio productions. The entertainment industry has also, likewise, been able to capitalize on this new dynamic forum as a new venue for serial productions to interactive on-line video games.

As more information and content is brought online, the ability to categorize, search, personalize, and retrieve the information is placing new demands on consumers, who are increasingly overwrought with a virtual information overload.

### BRIEF DESCRIPTION OF THE DRAWINGS

These and other features, aspects, and advantages of the present invention will become better understood with reference to the following description, appended claims, and accompanying drawings where:

FIG. 1 is a flow chart of the method of the present invention illustrating how a user selects content to view;

FIG. 2 is a view of an arbitrary web page of a web site from a web browser having the tool bar of the present invention illustrating step 1 shown in FIG. 1;

FIG. 3 is a view of the tool bar of the present invention in ‘Edit’ mode with content selected from the web page in two green filter boxes illustrating step 2 shown in FIG. 1;

FIG. 4 is a view of the content selected in Screenshot 2 while the present invention is in ‘View’ mode illustrating step 3 shown in FIG. 1;

FIG. 5 is a flow chart of the method of the present invention illustrating how a user selects content to block;

FIG. 6 is a view of the present invention being transitioned into ‘Exclude’ mode’ illustrating step 1 shown in FIG. 5;

FIG. 7 is a view of the present invention in ‘Edit’ mode with ‘Exclude’ mode set showing that the selected content in two red filter boxes illustrating step 2 shown in FIG. 5;

FIG. 8 is a view of the content of Screenshot 5 showing the unblocked content while the present invention is set in ‘View’ mode illustrating step 3 shown in FIG. 5;

FIG. 9 is a flow chart of the method of the present invention illustrating how a user selects content to view simultaneously from multiple websites;

FIG. 10 is a view of the ‘My Page’ function of the present invention illustrating step 1 shown in FIG. 9;

FIG. 11 is a view of the ‘Manage my Homepage’ function of the present invention illustrating step 2 shown in FIG. 9; and

FIG. 12 is a view of the ‘My Page’ function of the present invention with the co-browser function activated illustrating step 3 shown in FIG. 9.

### SUMMARY OF THE INVENTION

The present invention solves the problems of the prior art by providing a software program that enables an end-user consumer greater control over his or her web-viewing experience. In particular, the method and system of the present invention enables a consumer, using any standard web browsing software (such as Internet Explorer, Netscape, Mozilla, Firefox, Safari and Opera to name a few) to navigate to any web site on the internet and then selectively edit the contents that he or she wishes to view using a customized toolbar integrated into the web browser's interface.

Accordingly, among the objects of the present invention is the provision for a method of selectively viewing the content of various websites.

Another object of the present invention is the provision for a method of selectively blocking the content of various websites.

Yet, another object of the present invention is the provision for a method of constructing a custom webpage that includes many mini-portals of the content of a variety of websites.

Yet, another object of the present invention is the provision for a web browser plug-in module that can perform the various functions mentioned above.

### DETAILED DESCRIPTION OF THE PREFERRED EMBODIMENT

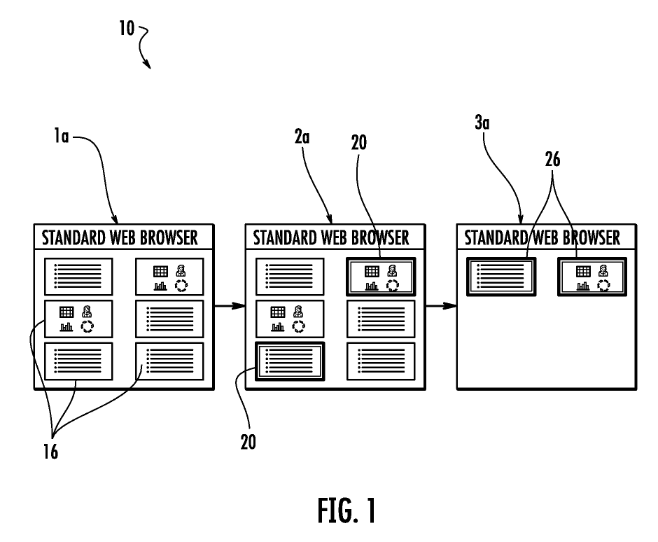

Referring to FIGS. 1, 5 and 9, the preferred embodiment of the method and system of the present invention is generally shown at 10, 100, and 200. In particular, the preferred embodiment of the present invention is a plug-in toolbar 12 that can be used with any standard web browser software 14 to allow a user to selectively display 10, block 100 or even rearrange 200 selected content of arbitrary websites 16 as desired.

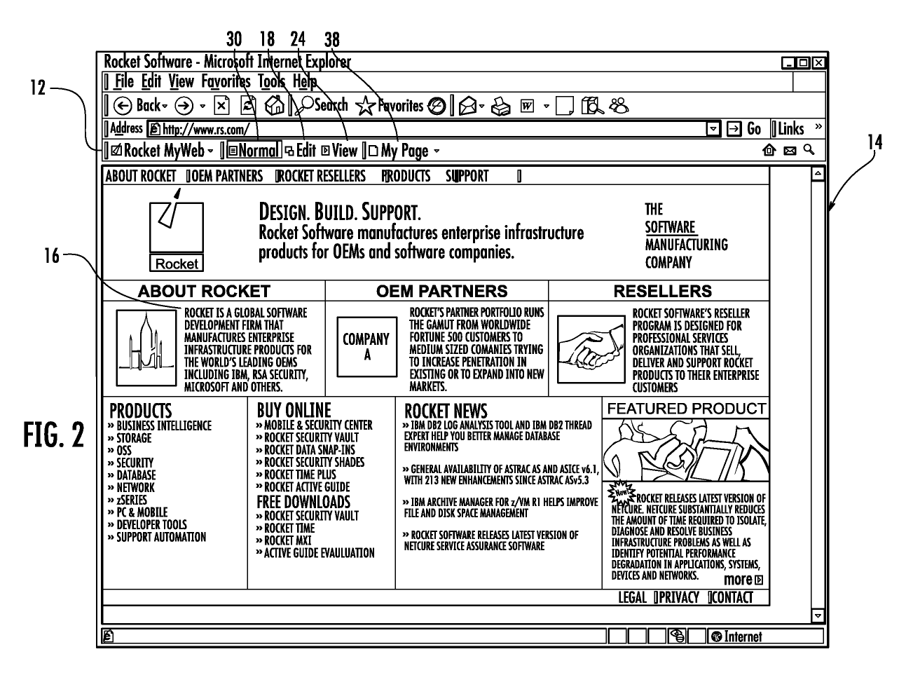

Referring back now FIG. 2, in a first step 1a, the end-user consumer navigates to a web page 16 of an arbitrary web site on the internet with a standard web browser 14.

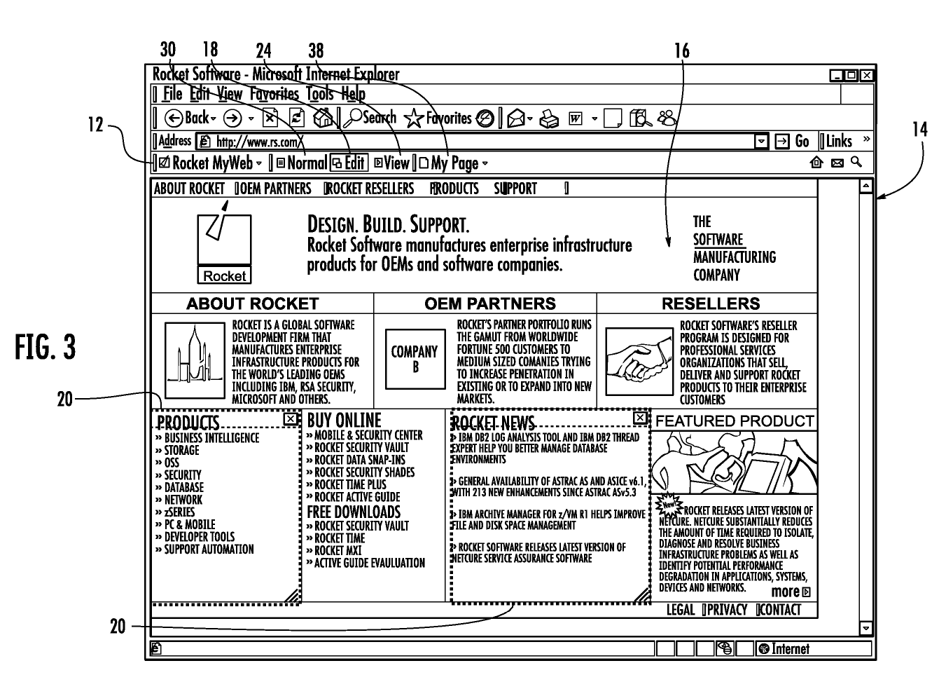

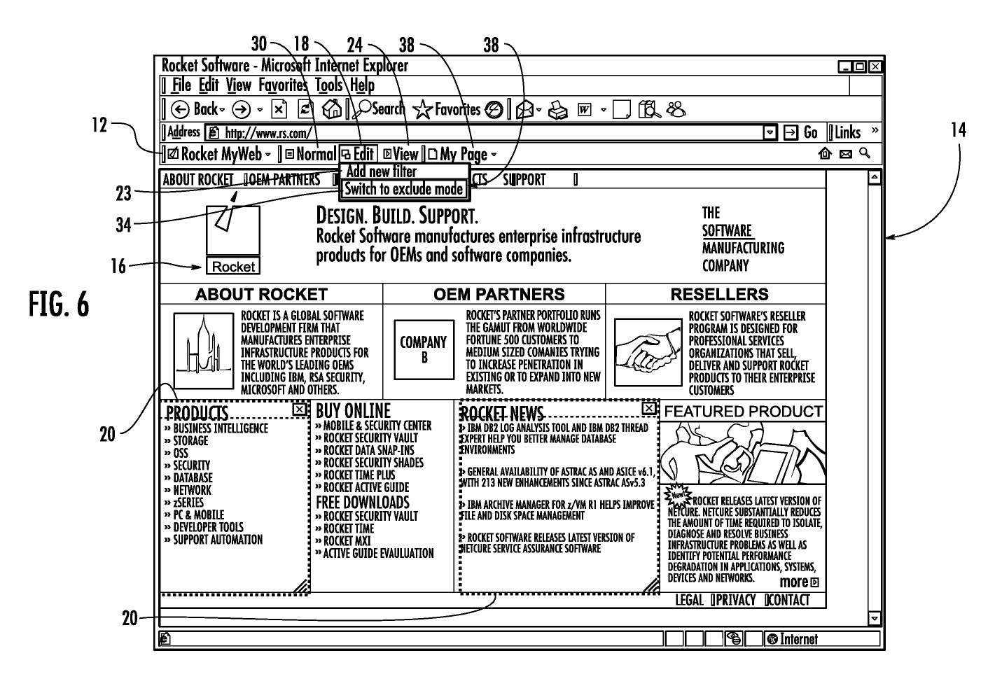

As shown in FIG. 3, in a second step 2a, the consumer then enters ‘edit’ mode where the consumer can select the content of the web page that he or she wishes to view. To enter ‘edit’ mode, the user merely clicks on the ‘edit’ button 18 on the toolbar 12. Upon entering edit mode, a green filter box 20 (indicated by the dashed line) is added to the page. The consumer positions and resizes the filter box 20 on the web page 16 such that it covers the page areas of interest. In this particular screenshot, the consumer has indicated that they are only interested in seeing two distinct areas of the web page 16 as indicated by the two green filter boxes 20 (shown in dashed lines). The default mode for selection of content is ‘Include’ mode, where the consumer selects desired content to see. Additional filters can be added via a popup menu 22 under the ‘Edit’ button 18, which is shown more clearly in FIG. 6. The user may create multiple filter boxes 20 to select multiple areas on the webpage 16 by selecting the ‘Add new filter’ command 23 from the ‘edit’ menu 22. Moreover, the consumer can rearrange the contents of the page to suit his or her individual preference or style.

In a third step 3a, the consumer then transitions to view mode to receive only the selected content from the web page by selecting the ‘View’ mode button 24 on the toolbar 12. The web page 16 alters to merely display the two regions 26 (weblets) selected within the filter boxes 20 in the prior step. The weblet 26 contains a user-editable caption-area 28 that the consumer can click on and type a meaningful title for the content.

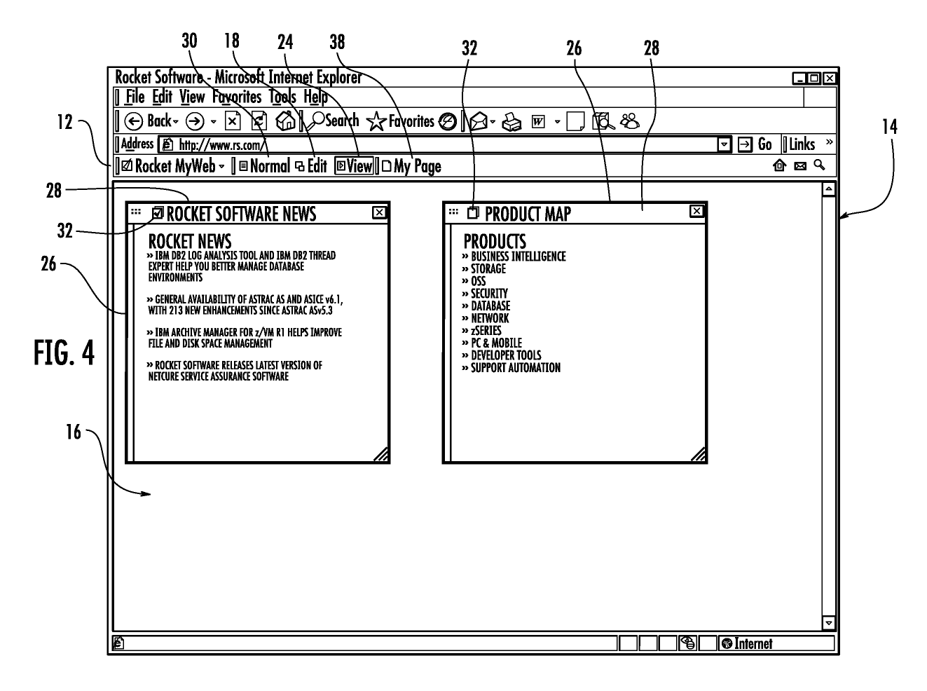

All subsequent visits to this web page 16 will now simply display these two regions 26 of the web page 16, for as long as the user sets the page to ‘view’ mode. The user can toggle between full page content or the filtered page by clicking among the ‘Normal’ button 30 (as seen in FIG. 2), ‘Edit’ button 18 (as seen in FIG. 3) or ‘View’ button 24 (as seen in FIG. 4) as desired. The invention applies the last used mode to the page 16 upon subsequent revisits.

It must be noted that the content for these regions is directly retrieved from the source web site; the invention does not store data. Rather, it merely customizes a web page 16 after it has been loaded by the web browser 14.

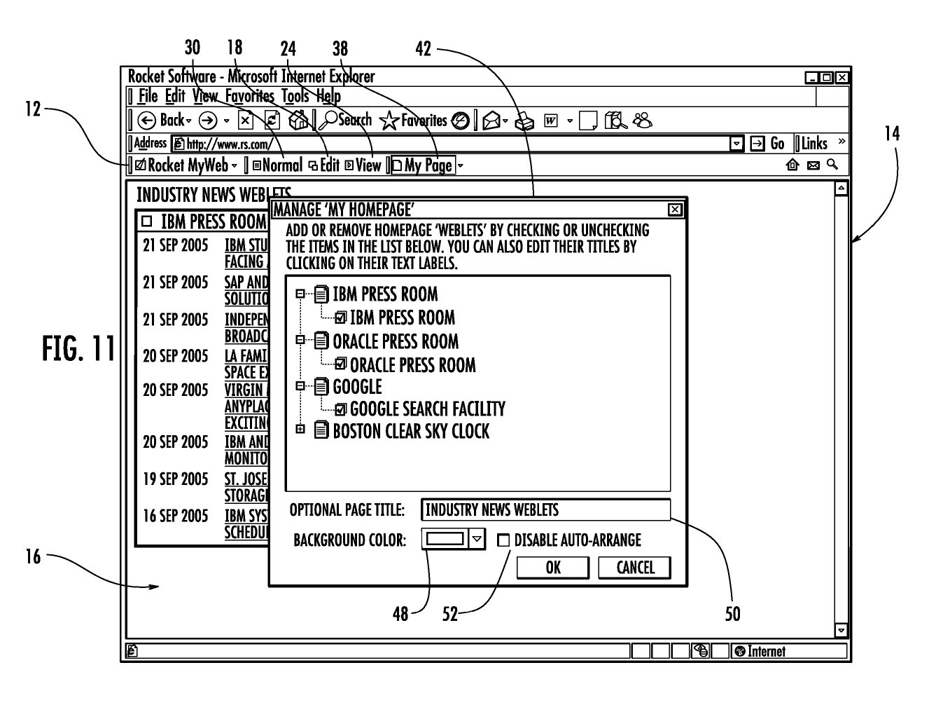

In addition, a checkbox 32 in the form of a ‘home’ icon allows the user to optionally add the weblet 28 to their own home page (and also as via the Manage ‘my homepage’ dialog shown in FIG. 11).

The method and system of the present invention preserves these consumer-selected settings allowing subsequent visits to the same web page 16 to continue to show only the consumer-selected content 28 organized in accordance with the consumer's settings.

Upon selecting a sub-section of the underlying web site 16 to be viewed, the method and system of the present invention computes and stores unique attributes of the selection 28 such that the same elements of the web page 16 can be automatically relocated upon subsequent visits to the web page 16. In this manner, the web page 16 content is always limited to the collection of selections made by the user, positions and locations also being specified by the user.

Attributes gathered for each page selection include element types, position in the document object model, sibling attributes, child element attributes, and element hyperlink properties. Collectively, these attributes form a unique signature for each selected region of the web page 16 and permit the page content to be tailored, independent of page content revisions, for as long as fundamental page structure remains unchanged.

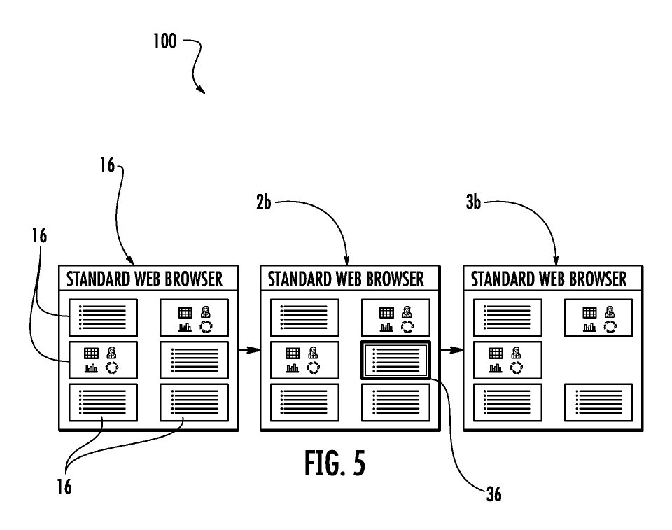

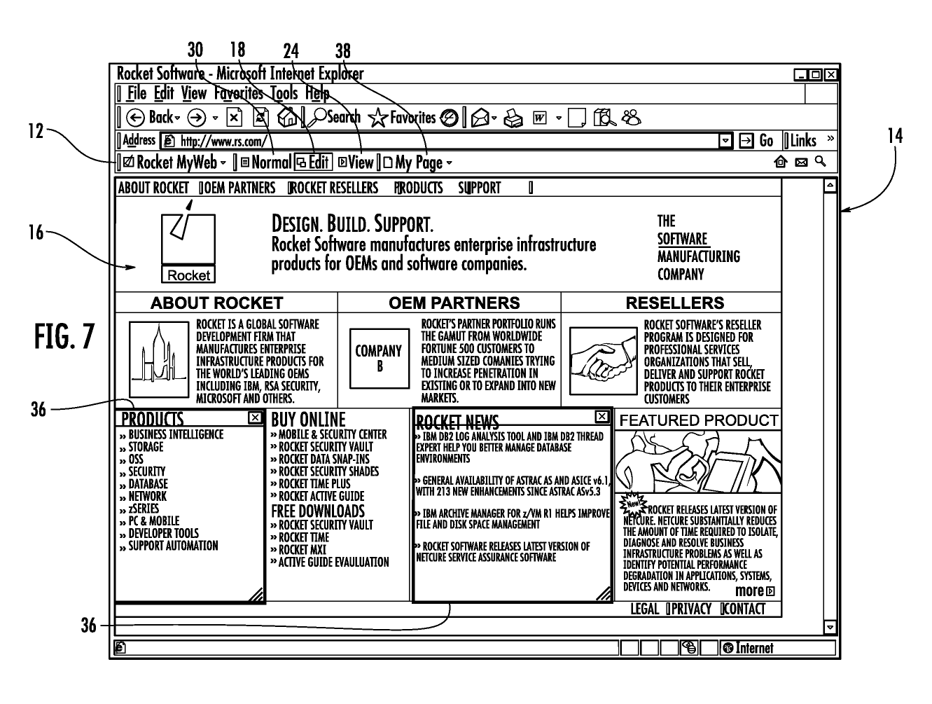

Referring to FIGS. 5-8, alternatively, the end-user consumer can deselect, rather than select, the content of the web page 16 that he or she does not wish to view. In other words, the consumer can choose to block certain content and allow all other content to be received rather than selecting only certain content to be received. As seen in FIG. 6, in a first step 1b, the consumer merely selects ‘Exclude’ mode 34 from the ‘Edit’ menu 22 to block the selected content. Upon entering ‘Exclude’ mode, the green filter boxes 20 (shown in dashed lines) change color to red filter boxes 36 (shown in bold lines) as shown in FIGS. 5 and 7, indicating that they will block the selected content. In a second step 2b, the red filter boxes 36 may moved and resized in the same manner as the green filter boxes 20 are in ‘Include’ mode.

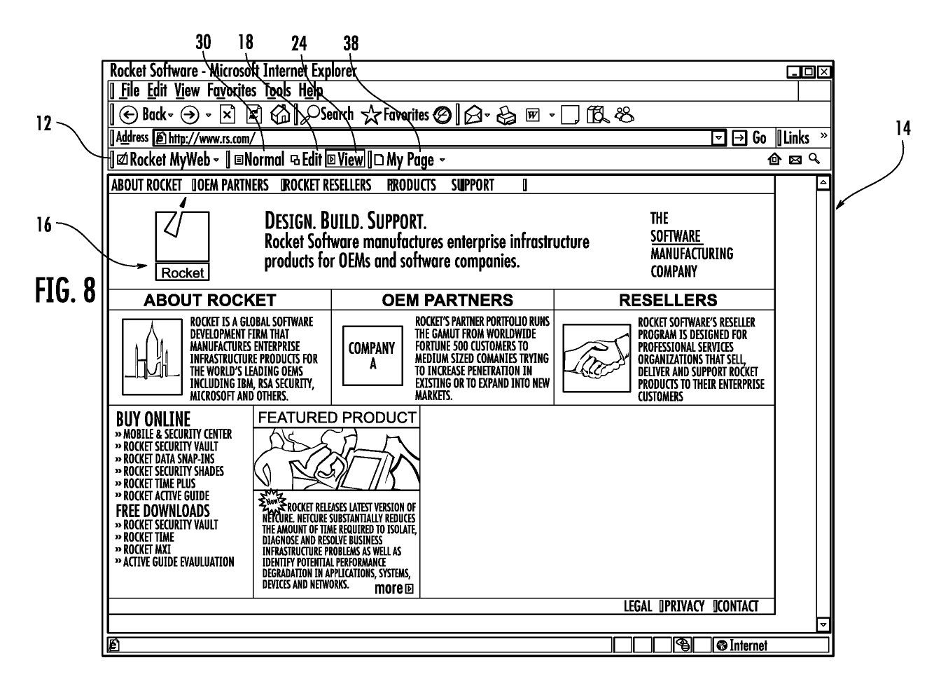

In a third step 3b, upon entering ‘View’ mode 24 as show in FIGS. 5 and 8, the selected content 36 is blocked from view, leaving the remaining page content 16 visible in the web browser 14. As with ‘Include’ mode, subsequent visits to this page 16 will continue to modify the web page content after it has been retrieved from the underlying web site for as long as the user remains in ‘view’ mode 24. Selecting ‘normal’ mode 30 will return the page to its original contents. Similarly, the consumer may also rearrange the contents of the web page 16 to suit his or her preferences. These settings are also preserved so that on subsequent visits to the same web site 16, the consumer's preferences are maintained revealing only the desired content and in the desired arrangement.

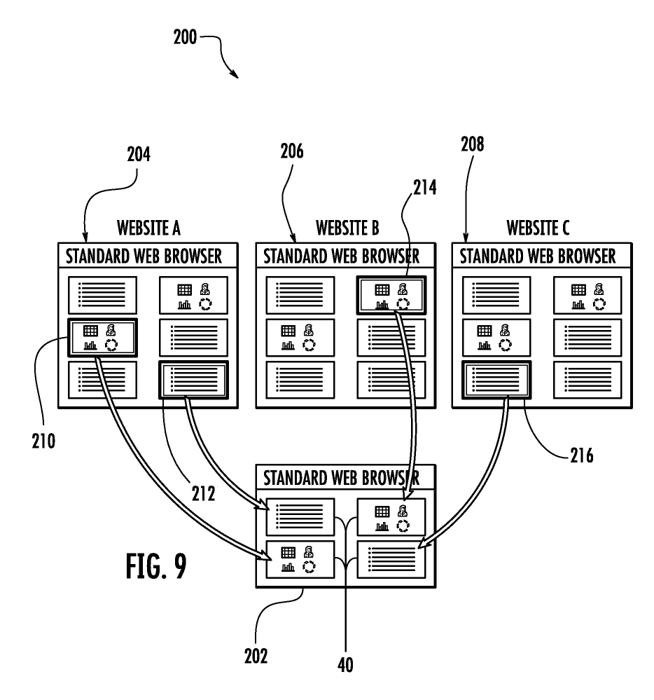

Referring to FIGS. 9-12, the end-user consumer can create an entirely new web page 202 constructed of the content selected from multiple web pages 204, 206, 208 residing at entirely different web pages or web sites. The consumer views these consumer-created pages by selecting ‘My Page’ button 38, which displays a collection of weblets 40 that have been assembled by the consumer from various, disparate web sites 204, 206, 208. Each weblet 40 reflects the live content 210, 212, 214, 216 from the respective web site 204, 206, 208 that it was drawn from.

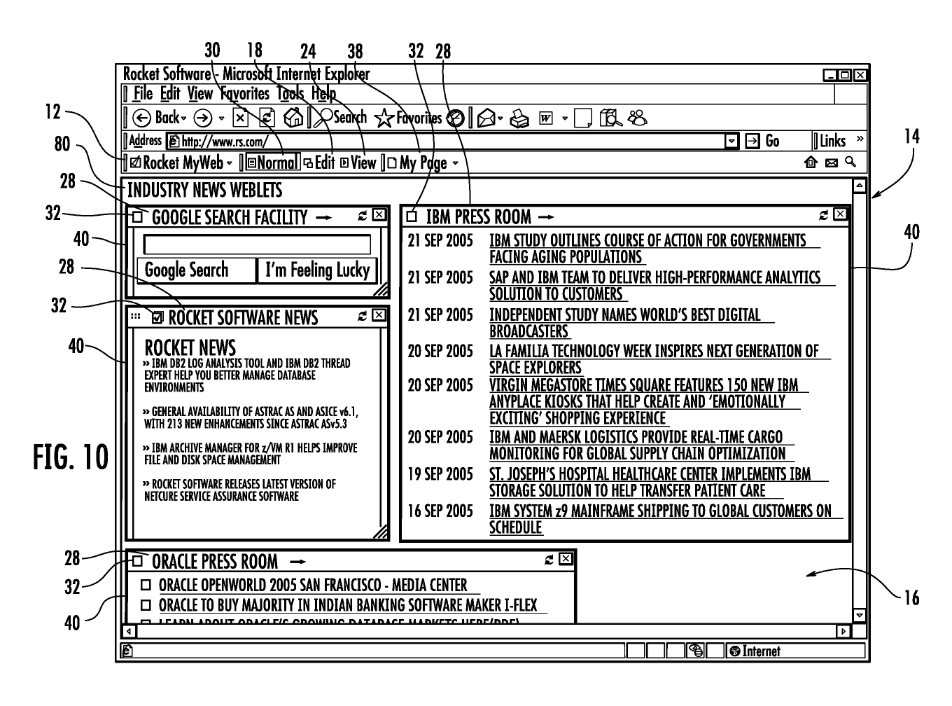

Referring to FIGS. 9 and 10, as with ‘view’ mode at a given web site (as shown in FIG. 4), weblets 40 can be rearranged on the page by clicking and dragging them, much as one would do with a regular application window. In this respect, the consumer arranges the content 210, 212, 214, 216 in a series of mini-portals 40 that he or she wishes to receive on a blank canvas 202. In this respect, the consumer can create a single, unified web page 202 consisting of content 210, 212, 214, 216 selected from any number of disparate web sites 204, 206, 208. The method and system of the present invention can then preserve the settings for this new consumer-designed page for latter retrieval by the consumer.

Referring to FIG. 11, the ‘manage my homepage’ function 42 allows the user to select specific weblets 40 for inclusion on the home page 202. Access to the ‘manage my homepage’ function is through the ‘My Page’ drop-down menu 38. The consumer can add or remove ‘weblets’ 40 and can also edit the titles 44 and the labels 46 from the ‘manage my homepage’ function 42. It must also be noted that the ‘manage my homepage’ function 42 also permits the setting of a background color 48 and an optional page tile 50 for the consumer-created web page 202. Additionally, the consumer may disable 52 the auto-arrange feature and manually control the layout of the weblets 40 on the user created web page 202.

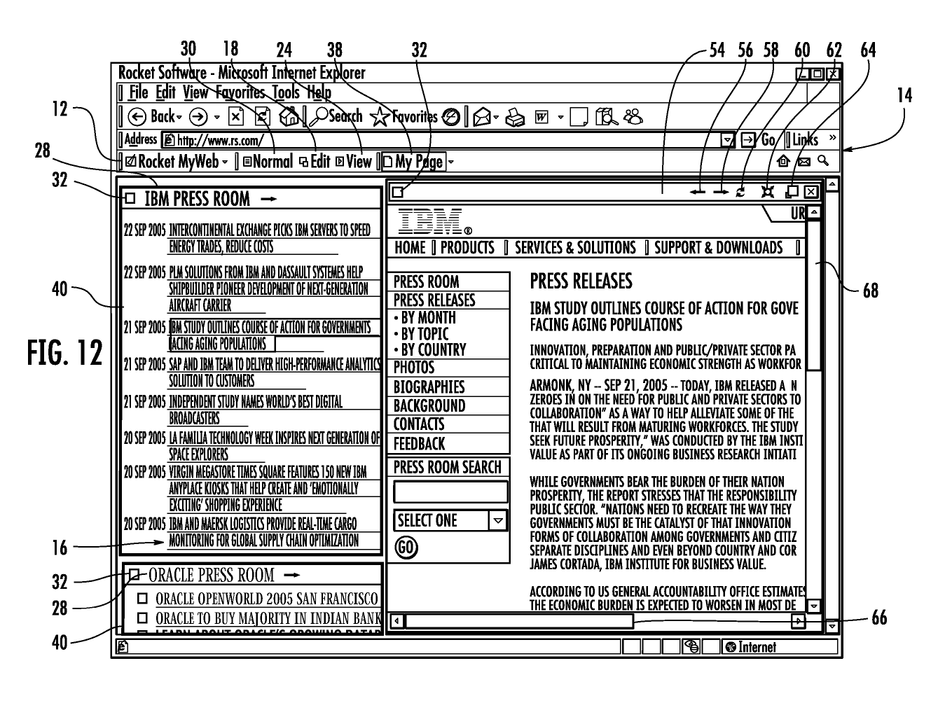

Referring to FIG. 12, when the user clicks on a link within a specific weblet 40, the target web page 210, 212, 214, 216 is displayed in a co-browser window 54 on the consumer's home page 202. In addition, the clicked item is highlighted to indicate the selected content. As each link in the weblet 40 is clicked, content 210, 212, 214, 216 in the co-browser 54 is recycled. In this manner, the consumer can conveniently review the summary content without having to navigate to and from the home page.

The co-browser window caption area also contains icons for to be able to navigate back 56, navigate forward 58, refresh the content 60, display the content in full browser area 62 (in other words, replace ‘my home page’ with this content) and to display the content in a new separate, full web browser window 64. The co-browser window 54 may also include horizontal and vertical slide controls 66, 68 to be able to pan the content to the website.

It must be emphasized that the selected content is still retrieved from the originating web site 210, 212, 214, 216 and that, therefore, the consumer is continually viewing the current content posted thereon. Accordingly, as a web site 210, 212, 214, 216 is updated, the consumer will still be able to view the updated portions that have been selected as per the consumer's preferences.

Therefore, it can be seen that the present invention provides a unique solution to allowing end-user consumers more control over their web browsing experiences by providing them a method and system to selectively view and organize the content of disparate web sites.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A method of selectively viewing the content of a webpage from a website using web browsing software, comprising the steps of:
navigating to at least one webpage of at least one website;
entering an edit mode;
selecting at least one subset of said at least one web page to apply at least one predefined display effect thereto;
entering a display mode;
wherein upon entering said display mode applies said at least one predefined display effect to said at least one subset of said at least one webpage.

2. The method of claim 1, wherein said display of said at least one subset may be rearranged as the user desires on said at least one webpage.

3. The method of claim 1, wherein said at least one predefined display effect allows only said at least one subset to be displayed.

4. The method of claim 1, where said at least one predefined display effect blocks said at least one subset from being displayed.

5. The method of claim 1, further comprising the steps of:
providing a blank webpage;
arranging said at least one subset of at least one webpage on said blank webpage as the user desires.

6. The method of claim 1, wherein said user may selectively switch between said predefined display effects.

7. A method of selectively viewing the content of a webpage from a website using web browsing software, comprising the steps of:
providing a blank webpage;
navigating to at least one webpage of at least one website;
entering an edit mode;
selecting at least one subset of said at least one web page to apply at least one predefined display effect thereto;
arranging said at least one subset of at least one webpage on said blank webpage as the user desires.
entering a display mode;
wherein upon entering said display mode applies said at least one predefined display effect to said at least one subset arranged on said blank webpage.

8. A plug-in for web browsing software for selectively viewing the content of a webpage from a website, comprising:
means for selecting at least one subset of said at least one web page to apply at least one predefined display effect thereto;
means for applying said predefined display effect to said at least one subset of said at least one webpage.

9. The plug-in of claim 8, wherein said display effect allows said at least one subset to be rearranged on the at least one webpage as the user desires.

10. The plug-in of claim 8, wherein said at least one predefined display effect allows only said at least one subset to be displayed.

11. The plug-in of claim 8, where said at least one predefined display effect blocks said at least one subset from being displayed.

12. The plug-in of claim 8, further comprising:
means for selectively arranging said at least one subset of at least one webpage on a separate blank webpage.

13. A plug-in for web browsing software for selectively viewing the content of a webpage from a website, comprising:
an edit function for selectively marking a subset of a webpage with a predefined display effect;
a view function for applying said predefined display effect to said webpage;
a normal function for removing said predefined display effect from said webpage.

14. The plug-in of claim 13, wherein said predefined display effect allows only said subset from said webpage to be displayed.

15. The plug-in of claim 13, where said predefined display effect blocks said at subset from said webpage from being displayed.

16. The plug-in of claim 13, further comprising:
a my page function for arranging a plurality of subsets from a plurality of webpages on a blank webpage and applying said predefined display effect to said blank webpage.
